(19) United States
(12) Patent Application Publication
(10) Pub. No.: US 2018/0106886 A1
(43) Pub. Date: Apr. 19, 2018

(54) RADAR LEVEL TRANSMITTER WITH DUST REMOVING STRUCTURES

(71) Applicant: FINETEK Co., Ltd., New Taipei City (TW)

(72) Inventors: I-Chu LIN, New Taipei City (TW); Yao-Chen YU, New Taipei City (TW); Chao-Kai CHENG, New Taipei City (TW); Yi-Liang HOU, New Taipei City (TW)

(21) Appl. No.: 15/294,674

(22) Filed: Oct. 14, 2016

(51) Int. Cl. G01S 7/40; G01F 23/284

(52) U.S. Cl. CPC G01S 7/4004; G01S 2007/4043; G01F 23/284

(57) ABSTRACT

A radar level transmitter (1, 1a) includes a detection body (10, 10a), an antenna body (20, 20a) and a film sheet (30, 30a). The detection body (10, 10a) has a circuit board (12) being capable of emitting signals of detection and receiving reflected signals. One end of the antenna body (20, 20a) connects with the detection body (10, 10a). The film sheet (30, 30a) is combined with the antenna body (20, 20a) and covers another end of the antenna body (20, 20a); an airflow passes through the film sheet (30, 30a) for being capable of removing dusts adhered to the film sheet (30, 30a). Therefore, a radar level transmitter (1, 1a) with dust removing structures is achieved and a regular cleaning by personnel is not necessary.

### BACKGROUND OF THE INVENTION

### Field of the Invention

The present invention generally relates to a level transmitter and, more particular to, a radar level transmitter with dust removing structures.

### Description of Prior Art

A radar level transmitter is a non-contact measurement adopting micro pulses and can be installed in various kinds of metal or non-metal containers or pipelines, thus it has advantages of easy to install, easy to maintain, high precision and can be utilized in a wide range of occasions.

Generally speaking, a radar level transmitter is applicable in environments being dusty, under large variation of temperature and pressure, and in circumstances of inert gases, steam or strong corrosive materials for performing a non-contact continuous measuring of liquid, slurry or grain materials. However, when the radar level transmitter is installed and operated in a powder material environment or under a high temperature and steam environment, the radar level transmitter is covered by dust or powders in the environment easily that results in a large accuracy error of the level transmitter and even losses of detection. As a result, the radar level transmitter needs to be cleaned regularly. However, this will not only increases labor costs but also affects the reliability of measurement results. Therefore, it does not meet the demands of use.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a radar level transmitter with dust removing structures for improving the inconvenience of regular cleaning and avoiding the risk of cleaning in a harsh environment as to increase the convenience of use.

Accordingly, another object of the present invention is to provide a radar level transmitter with dust removing structures as to be maintained in a normal measurement condition with measurement accuracy as to increase the practicality of use.

In order to achieve the object mentioned above, the present invention provides a radar level transmitter with dust removing structures including a detection body, an antenna body, and a film sheet. The detection body has a circuit board being capable of emitting signals of detection and receiving reflected signals. One end of the antenna body connects with the detection body. The film sheet is combined with the antenna body and covers another end of the antenna body, wherein airflow passes through the film sheet for being capable of removing dusts adhered to the film sheet.

In order to achieve the object mentioned above, the present invention provides a radar level transmitter with dust removing structures, which operates in coordination with a working gas, including a detection body, an antenna body, and a film sheet. The detection body has a gas transmission passage and a circuit board being capable of emitting signals of detection and receiving reflected signals. The antenna body has a hollow chamber. The antenna body has a first opening and a second opening at two ends of the hollow chamber separately, and the first opening connects with the detection body. The film sheet is combined with the antenna body and covers the second opening of the antenna body; wherein the working gas passes the gas transmission passage and makes the film sheet deformed for removing dust adhered to the film sheet.

Comparing to the prior art, the radar level transmitter with dust removing structures of the present invention combines the film sheet with the antenna body and covers another end of the antenna body. When an airflow passes through the film sheet, dust adhered to an outer side of the film sheet will be removed so that a regular cleaning is not necessary, thus it will increase the practicality and convenience of the radar level transmitter. In addition, the radar level transmitter of the present invention also provides with a gas transmission passage and operates in coordination with a working gas. When the working gas flows to the film sheet and makes the film sheet deformed, in which the film sheet is deformed through an expansion or a contraction by an act of the working gas. Thereby, dust adhered to the film sheet (an outer surface) will be removed; therefore, a function of cleaning the film sheet is achieved.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of the radar level transmitter with dust removing structures of the present invention;

FIG. 2 is a cross sectional schematic view of the radar level transmitter with dust removing structures of the present invention;

FIG. 3 is a partially enlarged schematic view of FIG. 2;

FIG. 4 is an operating schematic view of the radar level transmitter with dust removing structures of the present invention;

FIG. 5 is another embodiment of the radar level transmitter with dust removing structures of the present invention;

FIG. 6 is an air-blowing schematic view of a further embodiment of the radar level transmitter with dust removing structures of the present invention;

FIG. 7 is an air-inspiratory schematic view of a further embodiment of the radar level transmitter with dust removing structures of the present invention; and

FIG. 8 is a second embodiment of the radar level transmitter with dust removing structures of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

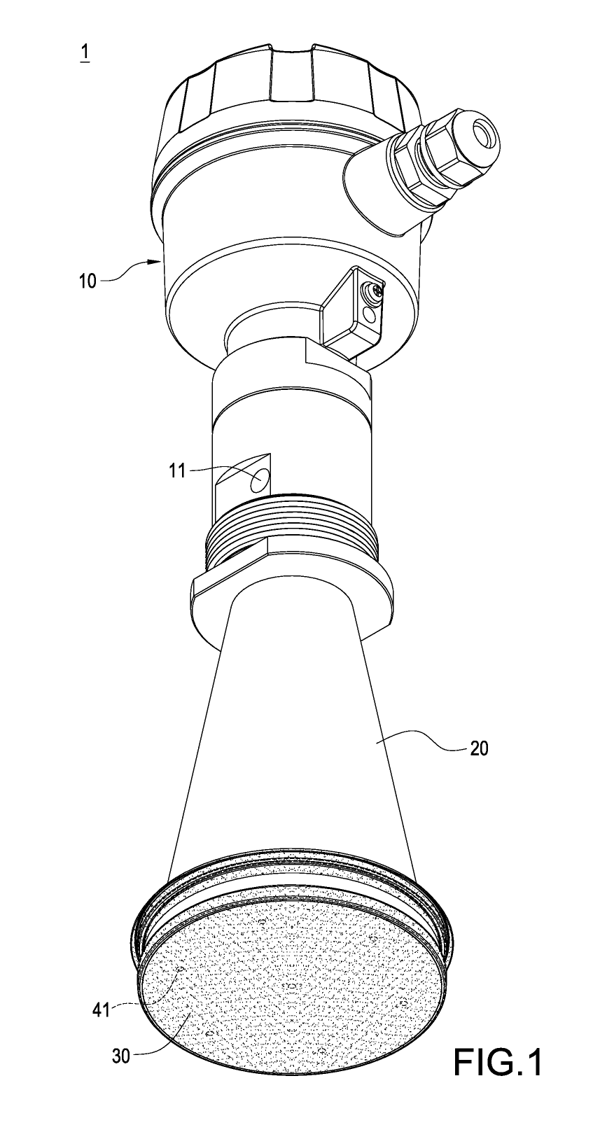

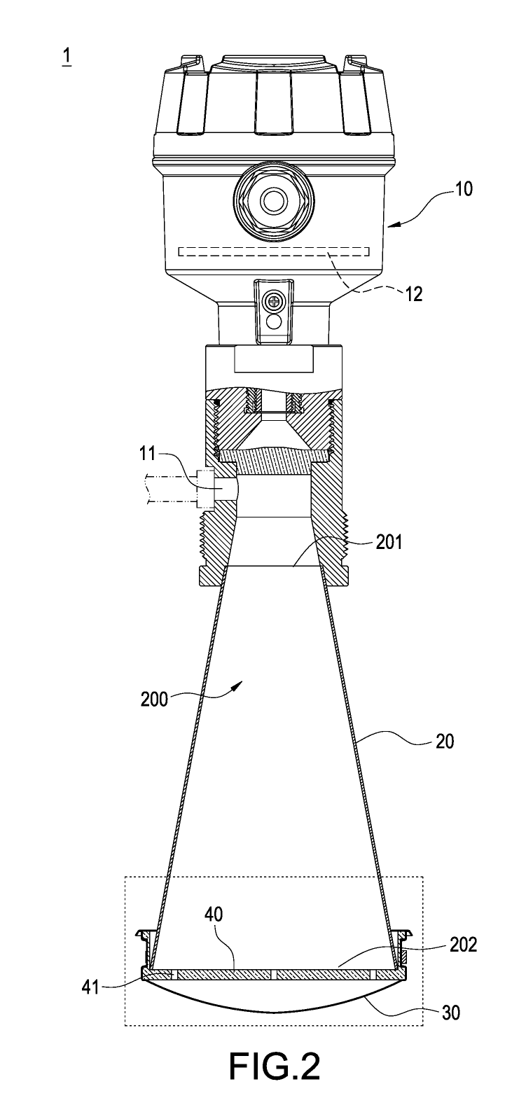

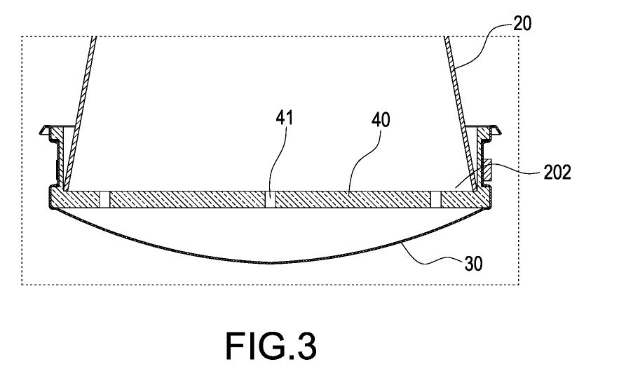

Please refer to FIG. 1 to FIG. 3, they depict a perspective schematic view, a cross sectional schematic view of the radar level transmitter with dust removing structures of the present invention, and a partially enlarged schematic view of FIG. 2. A radar level transmitter 1 with dust removing structures of the present invention includes a detection body 10, an antenna body 20 and a film sheet 30, wherein the antenna body 20 is combined with the detection body 10, and the film sheet 30 covers one side of the antenna body 20 as to configure the radar level transmitter 1.

The detection body 10 has a gas transmission passage 11 and a circuit board 12 being capable of emitting signals of detection and receiving reflected signals, and the gas transmission passage 11 is communicated with the inside of the antenna body 20.

The antenna body 20 has a hollow chamber 200. Besides, the antenna body 20 has a first opening 201 and a second opening 202 at two ends of the hollow chamber 200 separately, and the first opening 201 connects with the detection body 10. Preferably, the detection body 10 is horn-shaped for having a better radiation field that is beneficial for emitting signals of detection and receiving reflected signals as to perform a measurement.

Moreover, the film sheet 30 is combined with the antenna body 20 and covers the second opening 202 of the antenna body 20. Preferably, the film sheet 30 has a plurality of pores; in real practice, the film sheet 30 is made of non-woven fabric, glass fiber or fabric with fine holes and so on.

In one embodiment of the present invention, the radar level transmitter 1 further includes an antenna lens 40. The antenna lens 40 is located between the antenna body 20 and the film sheet 30. Besides, the antenna lens 40 is combined at the second opening 202 of the antenna body 20 and covered by the film sheet 30.

In the present embodiment, the antenna lens 40 has a plurality of gas transmission holes 41; preferably, the gas transmission holes 41 are arranged in an annular pattern with an evenly spaced interval.

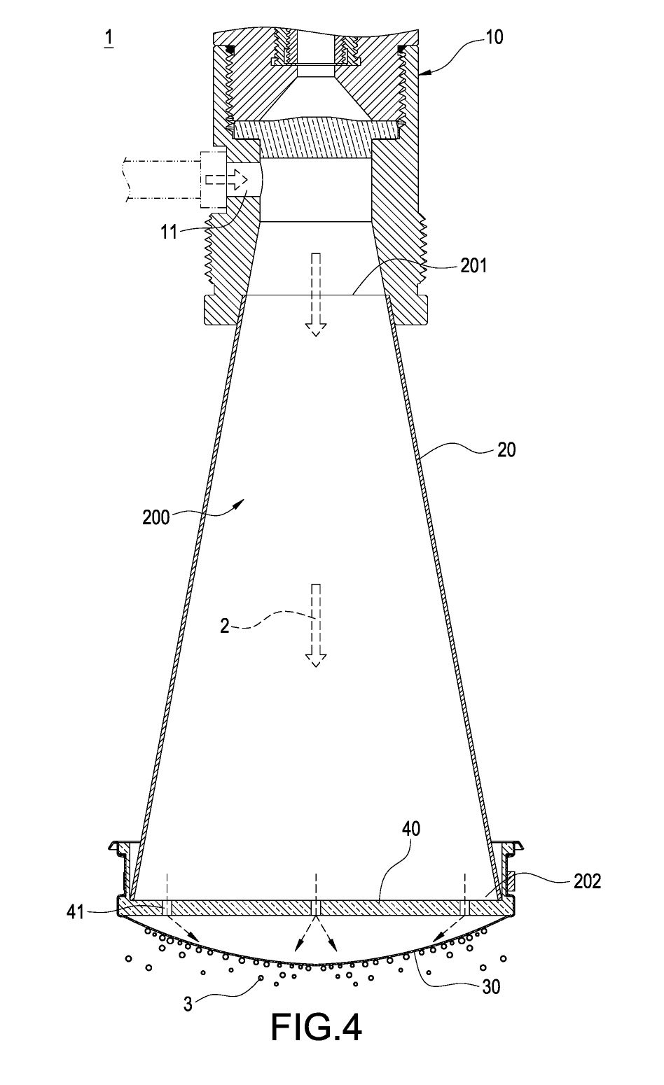

Please further refer to FIG. 4, it depicts an operating schematic view of the radar level transmitter with dust removing structures of the present invention. In the present embodiment, the radar level transmitter 1 operates in coordination with a working gas 2. The working gas 2 is used to generate airflow, therefore, the type of gas is not limited. In real practice, the working gas 2 is adoptable just for not reacting with the measuring object or the measuring environment.

As shown in FIG. 4, when the radar level transmitter 1 of the present invention is used, the working gas 2 passes through the gas transmission passage 11 and flows through the hollow chamber 200; then it passes through the antenna lens 40 and flows out from the gas transmission holes 41. At last, the working gas will flow to the film sheet 30 and makes the film sheet 30 deformed. More specifically, the film sheet 30 is deformed through an expansion or a contraction by an act of the working gas 2. Thereby, dust 3 adhered to the film sheet 30 (an outer surface) will be removed, and thus a function of cleaning the film sheet 30 is achieved.

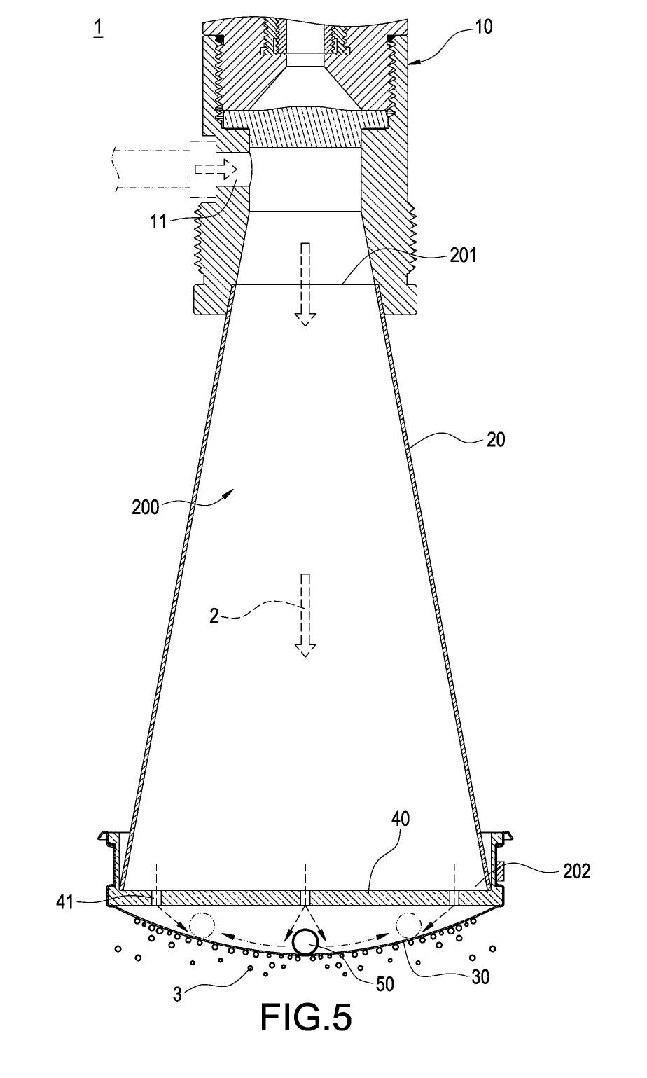

Please also refer to FIG. 5, it depicts another embodiment of the radar level transmitter with dust removing structures of the present invention. In the present embodiment, the radar level transmitter 1 further includes a sliding ball 50; preferably, the sliding ball 50 is a ball made of a low dielectric coefficient material. Furthermore, the sliding ball 50 is disposed on an inner side of the film sheet 30 and accommodated between the film sheet 30 and the detection body 10. Therefore, the sliding ball 50 will be moved when the film sheet 30 is deformed for removing dust adhered to the film sheet 30 (an outer surface).

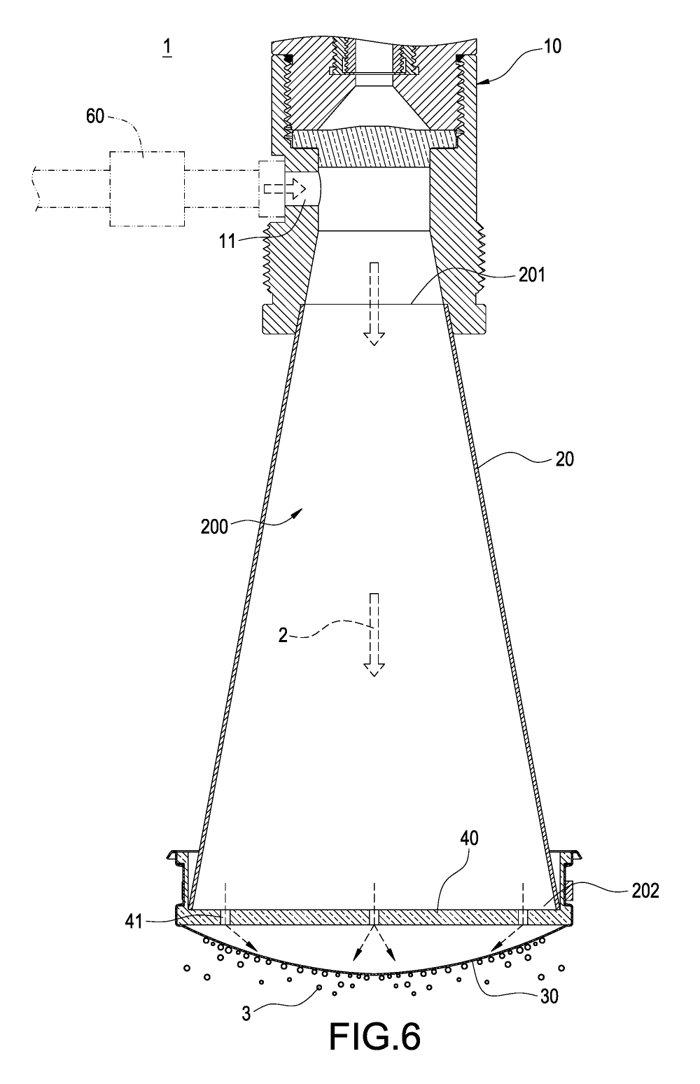

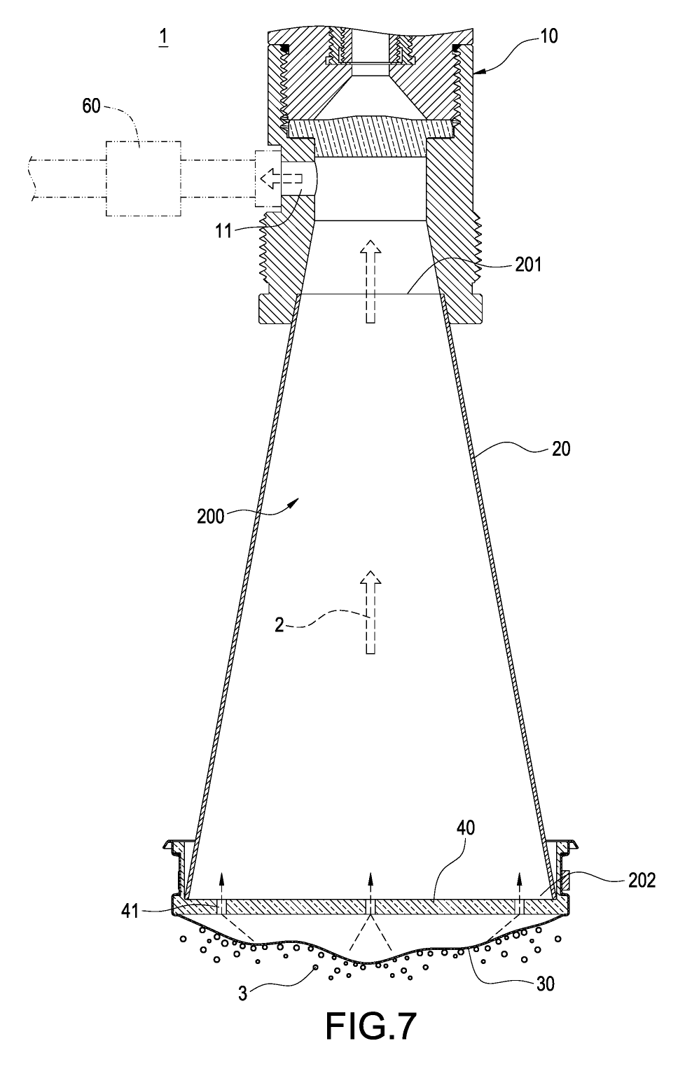

With further referring to FIG. 6 and FIG. 7, they depict another embodiment of the radar level transmitter with dust removing structures of the present invention. In the present embodiment, the radar level transmitter 1 further includes a solenoid valve 60. In addition, the solenoid valve 60 controls the working gas 2 out of the gas transmission passage 11. More specifically, there is a pressure difference between the working gas 2 and outside air; the pressure difference causes the film sheet 30 to be vibrated so that dust 3 adhered to the film sheet 30 (an outer surface) will be removed; thus a function of cleaning the film sheet 30 is achieved.

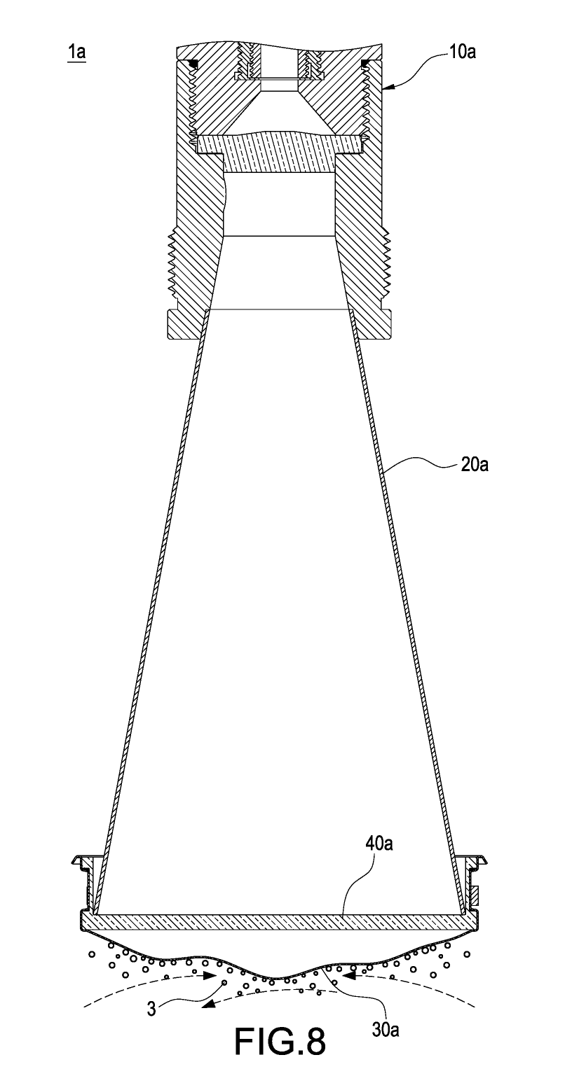

Please further refer to FIG. 8, it depicts a second embodiment of the radar level transmitter with dust removing structures of the present invention. In the present embodiment, a radar level transmitter 1a includes a detection body 10a, an antenna body 20a and a film sheet 30a. The detection body 10a has a circuit board (not shown) being capable of emitting signals of detection and receiving reflected signals. Besides, one end of the antenna body 20a connects with the detection body 10a. The film sheet 30 combines with the antenna body 20a and covers another end of the antenna body 20a.

Preferably, the radar level transmitter la further includes an antenna lens 40a. The antenna lens 40a is located between the antenna body 20a and the film sheet 30a. The antenna lens 40a is combined with the antenna body 20a and covered by the film sheet 30a.

A difference between the present embodiment and the previous embodiment is that the detection body 10a is not provided with a gas transmission passage, that is, the radar level transmitter 1a does not operate in coordination with a working gas. In real practice, when an outside airflow passes through an outer surface of the film sheet 30a, the airflow can make the film sheet 30a deformed and is capable of removing dust 3 adhered to the film sheet 30a.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A radar level transmitter (1, 1a) with dust removing structures, including:
a detection body (10, 10a) having a circuit board (12) being capable of emitting signals of detection and receiving reflected signals;
an antenna body (20, 20a) having one end connecting with the detection body (10, 10a); and
a film sheet (30, 30a) combined with the antenna body (20, 20a) and covering another end of the antenna body (20, 20a);
wherein, airflow passes through the film sheet (30, 30a) for being capable of removing dusts adhered thereon.

2. A radar level transmitter (1, 1a) with dust removing structures operating in coordination with a working gas (2), including:
a detection body (10, 10a) having a circuit board (12) being capable of emitting signals of detection and receiving reflected signals and having a gas transmission passage (11);
an antenna body (20, 20a) having a hollow chamber (200); the antenna body (20, 20a) having a first opening (201) and a second opening (202) at two ends of the hollow chamber (200) respectively, and the first opening (201) connecting with the detection body (10, 10a); and
a film sheet (30, 30a) combined with the antenna body (20, 20a) and covering the second opening (202) of the antenna body (20, 20a);
wherein, the working gas (2) passes the gas transmission passage (11) and makes the film sheet (30, 30a) deformed for removing dust adhered thereon.

3. The radar level transmitter (1, 1a) with dust removing structures according to claim 2, further including an antenna lens (40, 40a), wherein the antenna lens (40, 40a) is located between the antenna body (20, 20a) and the film sheet (30, 30a); the antenna lens (40, 40a) is combined at the second opening (202) and covered by the film sheet (30, 30a).

4. The radar level transmitter (1, 1a) with dust removing structures according to claim 3, wherein the antenna lens (40, 40a) has a plurality of gas transmission holes (41), and the gas transmission holes (4) are arranged in an annular pattern with an evenly spaced interval.

5. The radar level transmitter (1, 1a) with dust removing structures according to claim 2, wherein the film sheet (30, 30a) has a plurality of pores.

6. The radar level transmitter (1, 1a) with dust removing structures according to claim 2, further including a sliding ball (50), wherein the sliding ball (50) is disposed on an inner side of the film sheet (30, 30a) and accommodated between the film sheet (30, 30a) and the detection body (10, 10a); the sliding ball (50) will be moved when the film sheet (30, 30a) is deformed for removing dust adhered to the film sheet (30, 30a).

7. The radar level transmitter (1, 1a) with dust removing structures according to claim 6, wherein the sliding ball (50) is a ball made of a low dielectric coefficient material.

8. The radar level transmitter (1, 1a) with dust removing structures according to claim 2, further including a solenoid valve (60), wherein the solenoid valve (60) controls the working gas (2) out of the gas transmission passage (11); the film sheet (30, 30a) is deformed through an expansion or a contraction by a flow of the working gas.

9. The radar level transmitter (1, 1a) with dust removing structures according to claim 2, wherein the film sheet (30, 30a) is made of non-woven fabric, glass fiber or fabric with fine holes.

10. The radar level transmitter (1, 1a) with dust removing structures according to claim 2, wherein the detection body (10, 10a) is horn-shaped.
